(19) United States
(12) Patent Application Publication
(10) Pub. No.: US 2025/0059687 A1
(43) Pub. Date: Feb. 20, 2025

(54) KNOT-ARCHITECTURED FABRIC ACTUATOR AND APPLICATION USING THE SAME

(71) Applicant: Korea Advanced Institute of Science and Technology, Daejeon (KR)

(72) Inventors: Ilkwon OH, Daejeon (KR); Huapeng ZHANG, Daejeon (KR); Saewoong OH, Daejeon (KR)

(73) Assignee: Korea Advanced Institute of Science and Technology, Daejeon (KR)

(21) Appl. No.: 18/791,894

(22) Filed: Aug. 1, 2024

(30) Foreign Application Priority Data
Aug. 14, 2023 (KR) 10-2023-0106007

(51) Int. Cl. D04G 5/00; B25J 15/00

(52) U.S. Cl. CPC D04G 5/00; B25J 15/0033; D10B 2401/046

(57) ABSTRACT

The present disclosure relates to a knot-architectured fabric actuator using a knot shape and an application using the same. The knot-architectured fabric actuator includes at least one knot including a node formed by fiber strands crossing each other, and at least one petal including a closed curve formed by fibers extending from both ends of the knot. Further, the knot-architectured fabric actuator may be used as a wearable robot, a soft actuator, an adaptive sleeve, or the like.

### CROSS-REFERENCE TO RELATED APPLICATIONS

This application claims priority under 35 U.S.C. § 119 to Korean Patent Application No. 10-2023-0106007, filed on Aug. 14, 2023, in the Korean Intellectual Property Office, the disclosure of which is incorporated herein by reference in its entirety.

### TECHNICAL FIELD

The following disclosure relates to a fabric actuator, and more particularly, to a knot-architectured fabric actuator using a knot shape and an application using the same.

### BACKGROUND

Many types of functional fibers have been developed over the past decades, and the functional fibers have generally extended into a fabric by a fiber processing including weaving, knitting, and braiding processing. A smart fabric may be worn on a human body, and sense and respond to a change in an environment, and thus serve a fundamental function in designing future clothing that requires active actuating, energy harvesting, health monitoring, and thermal regulation functions. These smart functions of the fabrics have been derived from the functional fiber made of a miniature electronic device embedded therein, a shape memory alloy (SMA), a shape memory polymer, an electroactive polymer, a carbon nanotube, or a conductive polymer.

A fabric actuator has been spotlighted due to its outstanding function of realizing the smart fabric, has flexibility, elasticity, a light weight, a noise-free operation, a programming function, and the like, and may perform safe, comfortable, and controllable interactions with the human body or a vulnerable object. The fabric actuators have been developed based on various materials and designs over the past few years as follows: a multifunctional actuator using a torque unbalanced active yarn, an SMA-based fabric muscle for a wearable robot, an active patch for wearable interactions, a soft orthosis that assists a human body muscle, a compressive actuator that may adjust fit, or the like.

In order to improve the prescribed force and operational deformation of the fabric actuator, several factors such as its material, design, and processing can be considered. However, the fabric actuator has still been fabricated by using three common fabric architectures of conventional weaving, knitting, and braiding architectures. The fabric actuator, based on the three types of fabric architectures, has its own limitations despite a unique advantage of its suitability for different applications. In particular, a jersey knitted fabric actuator as shown in FIG. 1 may have a limitation in generating its force due to inefficient force transmission caused by sliding or kinetic friction occurring at a crossing point, a jersey knit architecture may be unable to properly function by Joule heating because a short circuit occurs therein to cause non-uniform heat distribution and irregular deformation, and an operating system of the actuator may have a limited portability because an additional bulky and heavy heating device is necessary when its electric heating is not available. In addition, the jersey knit architecture may not be stable against untying, and may thus easily come apart without any additional constraint like loose shoelaces.

These shortcomings may be a hindrance to applying the jersey knit architecture to a product, which leads to a need for a new fabric architecture that may meet the requirements of a high-performance fabric actuator.

### RELATED ART DOCUMENT

### Patent Document

(Patent Document 1) U.S. Patent Application Publication No. US 2019-0015233 A1 (published on Jan. 17, 2019)

### SUMMARY

An embodiment of the present disclosure is directed to suggesting a unit knot architecture which may ensure efficient force transmission and its stability against loosening, and providing a new fabric actuator which may generate a large force and deformation by the unit knots in linkage with each other in two dimensions, may be easily operated by Joule heating, and may maintain its mechanical robustness.

An embodiment of the present disclosure is also directed to suggesting a knot pattern having improved driving performance by expanding knots formed by a functional fiber and in linkage with each other into a one column actuator, and suggesting the knot pattern and column connection part, which are suitable for a knot-architectured fabric actuator.

An embodiment of the present disclosure is also directed to describing a mechanism of generating an advantage of the knot-architectured fabric actuator based on the theoretical analysis and experimental verification of the knot-architectured fabric actuator.

An embodiment of the present disclosure is also directed to suggesting a fabrication method of fabricating the knot-architectured fabric actuator, and suggesting practical application fields including a wearable actuator and an adaptive grip surface, to which the fabric actuator may be applied.

In one general aspect, a knot-architectured fabric actuator includes: at least one knot including a node formed by fiber strands crossing each other; and at least one petal including a closed curve formed by fibers extending from both ends of the knot.

The at least one knot and the at least one petal may extend in one direction to form a column.

The column may extend in the other direction to form a two-dimensional architecture.

Two or more of the two-dimensional architectures may overlap each other to form a multi-layer.

Two knots and two petals may form a unit knot.

The knot-architectured fabric actuator may satisfy d≤2w0. Here, w0 indicates a width of the unit knot, and d indicates a distance from one side of one unit knot to the other side of another unit knot adjacent thereto in a width direction when the unit knot extends in the width direction.

The fiber may be a shape memory polymer.

The knot-architectured fabric actuator may be used as a wearable robot, a soft actuator, an adaptive sleeve, or the like.

Other features and aspects will be apparent from the following detailed description, the drawings, and the claims.

### BRIEF DESCRIPTION OF THE DRAWINGS

FIG. 1 is a conceptual diagram for explaining the feature and shortcoming of a conventional jersey knit structure.

FIG. 2 is a conceptual diagram for explaining the feature and advantage of a knot architecture according to an embodiment of the present disclosure.

FIG. 3 is a diagram showing a form of the knot-architectured fabric actuator formed in a column according to an embodiment of the present disclosure.

FIG. 4 is a diagram showing a modified example of the knot-architectured fabric actuator having a two-dimensional architecture according to an embodiment of the present disclosure.

FIG. 5 is a diagram for explaining the knot formation method and architecture of a one-petal knot-architectured fabric actuator according to an embodiment of the present disclosure.

FIG. 6 is a diagram for explaining the knot formation method and architecture of a two-petal knot-architectured fabric actuator according to another embodiment of the present disclosure.

FIG. 7 is a diagram for explaining the knot formation method and architecture of a four-petal knot-architectured fabric actuator according to still another embodiment of the present disclosure.

FIG. 8 is a graph comparing the elongation strain, contraction strain, and work per unit length of the respective knot architectures with one another.

FIG. 9 is a graph comparing and evaluating performances of the knot architectures with one another based on the maximum power density and prescribed force applied thereto.

FIGS. 10 to 12 are diagrams showing various column connection types, where

FIG. 10 shows free connection, FIG. 11 shows mean connection, and FIG. 12 shows force connection.

FIG. 13 is a graph comparing the elongation strain, the contraction strain, the work per unit length of the respective knot architectures with one another for each column connection type.

FIG. 14 is a graph comparing and evaluating performances of the knot architectures with one another based on the maximum power density and prescribed force for each column connection type.

FIG. 15 shows results of testing a self-locking of the knot-architectured fabric actuator according to an embodiment of the present disclosure and a sliding operation of a conventional jersey knitted fabric actuator.

FIG. 16 is a diagram showing the temperature distribution and mechanical deformation of each of the knot-architectured fabric actuator according to an embodiment of the present disclosure and the conventional jersey knitted fabric actuator, during Joule heating.

FIG. 17 shows the photograph and modification of a multi-layer knot-architectured fabric actuator according to one embodiment of the present disclosure.

FIG. 18 shows an example of an adaptive sleeve using the knot-architectured fabric actuator according to an embodiment of the present disclosure.

### DETAILED DESCRIPTION OF EMBODIMENTS

Specific embodiments and features of the present disclosure are described in detail with reference to the accompanying drawings. However, the present disclosure is not limited to these specific embodiments and drawings, and may be implemented in various different forms. These embodiments are provided only to make the present disclosure complete and allow those skilled in the art to completely appreciate the scope of the present disclosure, and the present disclosure is defined by the scope of the claims. Throughout the specification, the same reference numeral denotes the same component.

In describing the embodiments of the present disclosure, omitted is a detailed description of a case where it is decided that the detailed description of the known functions or configurations related to the present disclosure may unnecessarily obscure the gist of the present disclosure. In addition, terms used herein are defined in consideration of their functions in the embodiments of the present disclosure, and may be construed in different ways by intentions of users or operators, practices, or the like. Therefore, the terms should be defined on the basis of the contents throughout the specification.

The knot may have good potential to implement a new fabric architecture. However, conventional research on the knot is mainly focused on a one-unit knot, and it is yet to consider application of the knot to a smart fabric actuator. Several unit knots may be in linkage with each other and expand in two dimensions. In this case, a new fabric architecture may be applied to a design for the development of a wearable fabric actuator. Performance and operation required for the actuator may be efficiently implemented by adjusting the pattern and connection of the knots. In addition, the knot architecture may be freely designed and applied to a high-performance fabric actuator.

The present disclosure relates to a knot-architectured fabric actuator capable of being used in a power suit or an adaptive grip surface. The fiber-based fabric actuator according to an embodiment of the present disclosure may generate greater force and drive deformation than a conventional actuator, and may be easily operated by Joule heating while ensuring its mechanical robustness. In the present disclosure, column connection between the unit knots may provide a comprehensive indicator, and achieve a high performance mechanism based on its self-locking feature and nearly-parallel cross direction.

The present disclosure suggests that the knot-architectured fabric actuator may have a different performance based on a knot architecture. In an embodiment, a two-petal knot architecture where the knot has two petals, is suggested as a unit knot architecture whose force transmission cross ratio serves an important function in the high-performance fabric actuator.

In addition, the present disclosure suggests that the knot-architectured fabric actuator may have a different performance based on a column type, and free connection of securing one petal to another column may be a connection type for reducing interference between the columns.

Hereinafter, referring to the accompanying drawings, the description specifically describes the architecture and fabrication method of the knot-architectured fabric actuator according to an embodiment of the present disclosure, and an application using the same.

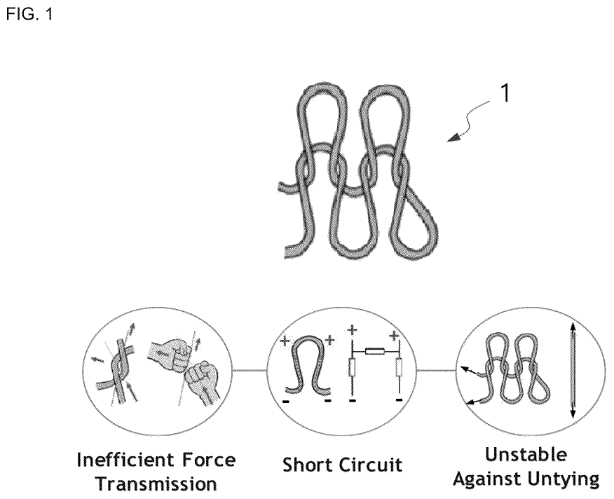

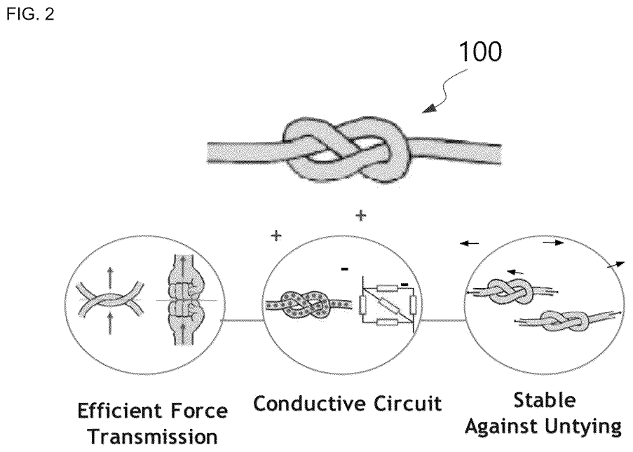

First, FIG. 2 is a conceptual diagram for explaining the feature and advantage of a unit knot architecture 100 according to an embodiment of the present disclosure. As described above, the conventional jersey knit structure 1 of FIG. 1 may partially lose its driving force due to sliding, kinetic friction, or cancellation of non-parallel force elements. On the other hand, the knot-architectured fabric actuator according to an embodiment of the present disclosure may maintain high force transmission efficiency between adjacent unit knots in a driving direction. In addition, in the conventional jersey knitted fabric actuator, non-uniform heat distribution may occur due to irregular deformation caused by a circuit shortened due to equipotential nodes symmetrical to the axis, and the knot may slip to be untied due to its topological equivalence with the untied knot. On the other hand, the knot-architectured fabric actuator according to an embodiment of the present disclosure may maintain uniformity under Joule heating due to non-equipotential adjacent nodes, and maintain its mechanical robustness because tension is applied to its end by a topological difference between the knots, which is different from the conventional jersey knit.

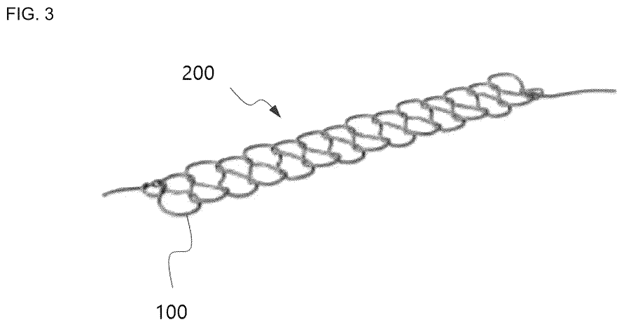

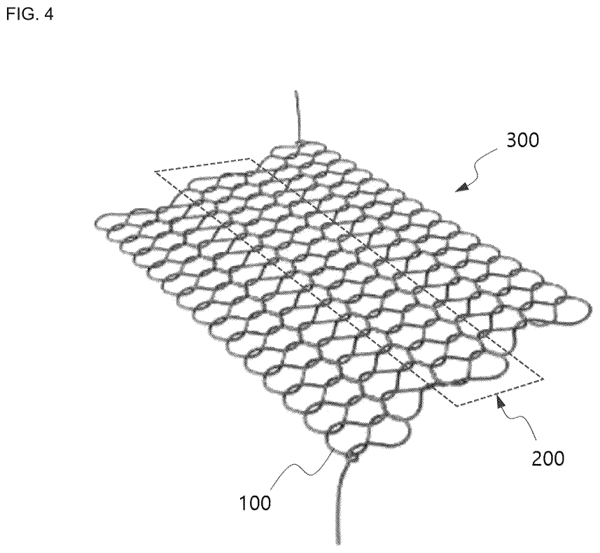

FIGS. 3 and 4 are diagrams for explaining a process from the unit knot architecture 100 to a two-dimensional knot-architectured fabric actuator 300. First, as shown in FIG. 3, the unit knot architecture 100 made of a functional fiber may be linked with each other to thus form a one column knot-architectured fabric actuator 200, and as shown in FIG. 4, the two-dimensional knot-architectured fabric actuator 300 may be formed when the one column knot-architectured fabric actuators 200 are connected with each other. In order to form the two-dimensional knot-architectured fabric actuator 300 from the unit knot architecture 100 through these two steps, it is necessary to determine a unique method in which two ends of the functional fiber cross each other, and train the fabric actuator to remember a curvature of the knot-based architecture.

In an embodiment of the present disclosure, the fabric actuator may use a nitinol wire, which is a shape memory alloy (SMA) material, among various functional fibers. The nitinol wire may remember its curvature through a shape training process, and be driven when activated by heat applied thereto to recover the memorized shape. From an energy conversion viewpoint, heat energy may be converted into kinetic energy in the shape recovery process, and an operation of the nitinol wire may be controlled using a portable battery when using Joule's law of resistance heating. The nitinol wire may have a light weight, flexibility, and sufficient force to withstand a large force during its operation, and thus be suitable for configuring the knot-architectured fabric actuator.

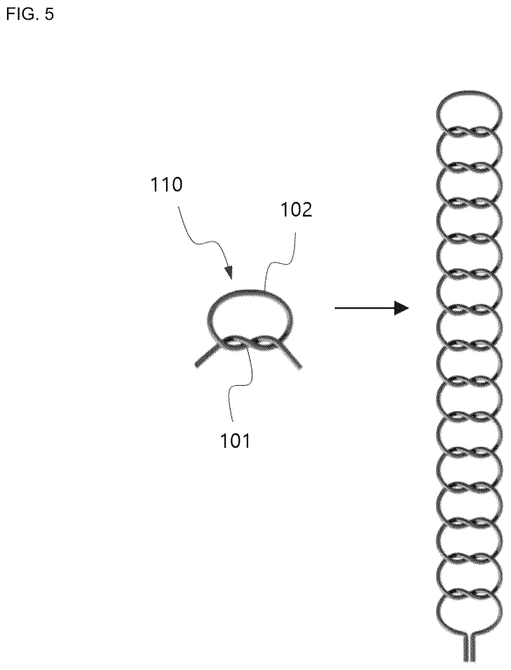

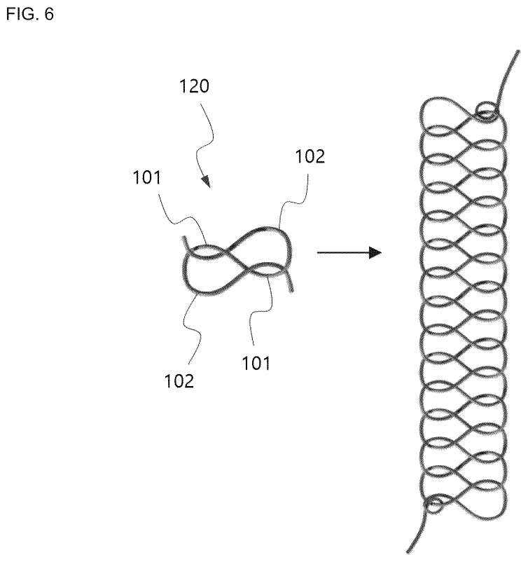

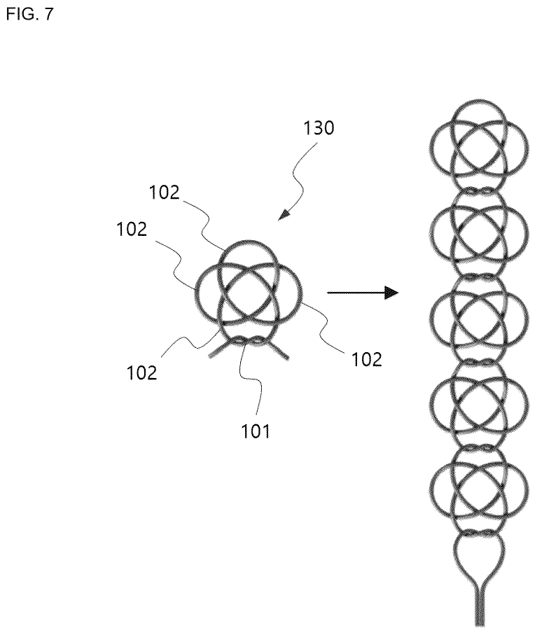

Meanwhile, the knot-architectured fabric actuator may have a different operation performance based on a knot pattern. Therefore, it is important to select a suitable knot pattern. FIGS. 5 to 7 are diagrams for explaining the knot formation method and architecture of the knot-architectured fabric actuators. FIG. 5 shows a one-petal knot 110 and a type in which the one-petal knot 110 expands into one column, the one-petal knot 110 having its unit knot configured by one knot 101 including a node formed by fiber strands crossing each other and one petal 102 including a closed curve formed by fibers extending from both ends of the knot 101; FIG. 6 shows a two-petal knot 120 having its unit knot configured by the two knots 101 and two petals 102 and a type in which the two-petal knot 120 expands into one column; and FIG. 7 shows a four-petal knot 130 having its unit knot configured by the four knots 101 and four petals 102 and a type in which the four-petal knot 130 expands into one column.

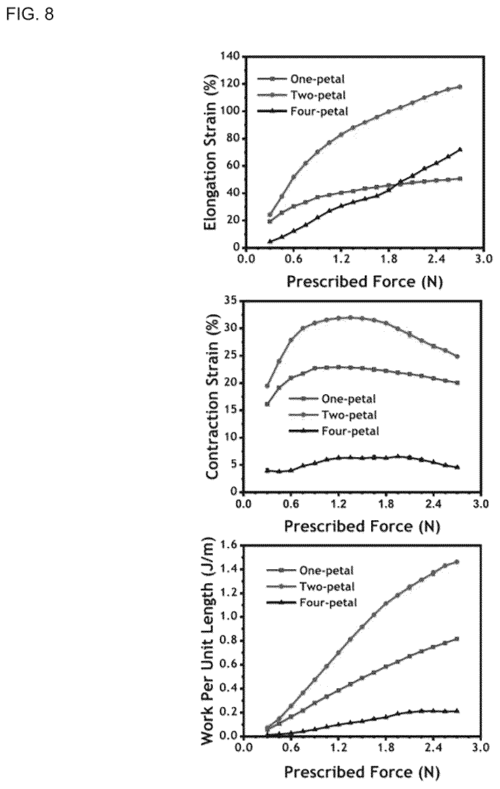

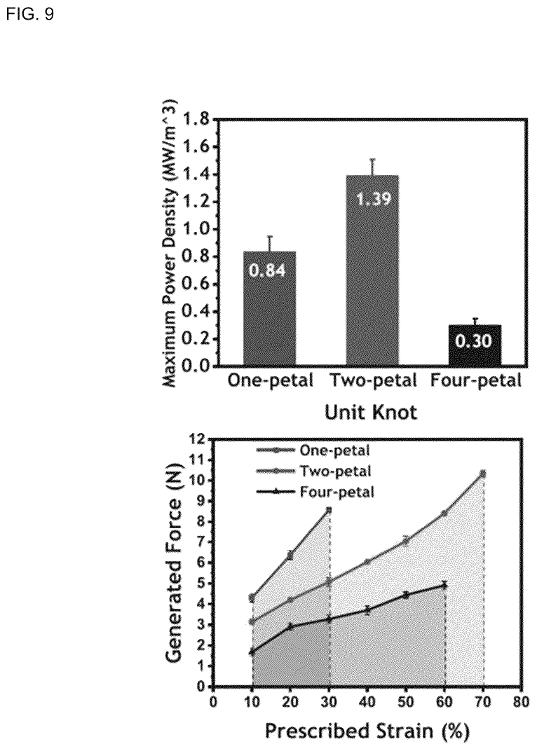

FIGS. 8 and 9 show experiment results of comparing an effect of the knot pattern on the operation performance of the knot-architectured fabric actuator, and compare comprehensive indicators of the knot-architectured fabric actuators with one another, the comprehensive indicators including the contraction strain, the elongation strain, work per unit length, maximum power density, and a generated force.

First, the uppermost graph of FIG. 8 compares elongation strains of the respective knot patterns with one another based on the prescribed force applied thereto. It may be seen that the elongation strain is increased by the prescribed force applied to the knot architecture, which reflects a stretch ability of the actuator. It may be seen that the elongation strain of the two-petal knot actuator reaches its maximum of 118% at 2.7 N, which is larger than the elongation strains of the other actuators. The one-petal knot and four-petal knot actuators are stiffer than the two-petal knot actuator, and both the actuators thus show an elongation of less than 75% at 2.7 N.

The middle graph of FIG. 8 compares the contraction strains of the respective knot patterns with one another based on the prescribed force applied thereto. The contraction strain may be calculated based on a current configuration of the actuator, unlike the elongation strain which is calculated based on its initial configuration. For example, an initial actuator length may be 100 mm. In this case, an elongation of 50 mm indicates an extension strain of 50%, and a contraction of 50 mm indicates a contraction strain of 33.3%. This difference is important in understanding different trends of these two types of strain curves. As shown in FIG. 8, the contraction strain caused by the prescribed force may be expressed as a convex curve reaching a peak value at a middle load applied to the knot pattern, may tend to be decreased due to a limited space for contraction at a low load applied thereto, and may tend to be decreased due to the large elongated actuator length as the denominator at a high load applied thereto. As shown in FIG. 8, the two-petal knot actuator may have a greater contraction strain than those of the other actuators, may have a contraction of 30% or more at 1.5 N, and may have the contraction strain gently decreased as the prescribed force is increased. On the other hand, the one-petal actuator shows its maximum contraction of 22.9% at 1.2 N, and the four-petal actuator shows a contraction of 10% or less regardless of the prescribed force. It may thus be seen that an operation capacity of the two-petal knot actuator is the highest.

The lowermost graph of FIG. 8 compares overall driving capabilities of the one-petal knot, the two-petal knot, and the four-petal knot with one another, and shows the work per unit length based on the prescribed force. As may be seen from data presented in the drawing, the two-petal knot actuator may perform the greatest work per unit length.

FIG. 9 is a graph comparing and evaluating the performances of the knot architectures with one another based on the maximum power density and prescribed force applied thereto. An upper graph of FIG. 9 shows the maximum power density for evaluating a time ratio of mechanical work, and it may be seen that the two-petal knot actuator may perform the mechanical work at the fastest speed. The lower graph of FIG. 9 compares strain control ranges of the knot architectures with one another based on the force to be generated therein. The one-petal actuator is not allowed to have the elongation of more than 50%. It may thus be seen that the narrowest strain range is selected for the one-petal actuator to test the generated force therein, and the one-petal actuator generates a high force in a strain range of zero to 30%.

On the other hand, the two-petal knot actuator may generate a force higher than those of the other two types of actuators and have a wider strain spectrum, reaching 10.3 N at 70%. The larger the specified strain spectrum, the shorter the actuator length is required for the same actuating stroke. Therefore, a two-petal knot actuator may be advantageous when considering both of the generated force and the required actuator length. As a result, it may be seen that a one column actuator using the two-petal knot as its unit knot has better performance, including higher elasticity, operation contraction, mechanical work, power density, and generated force.

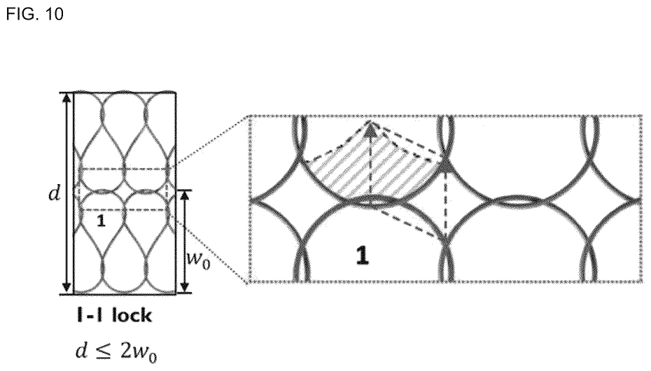

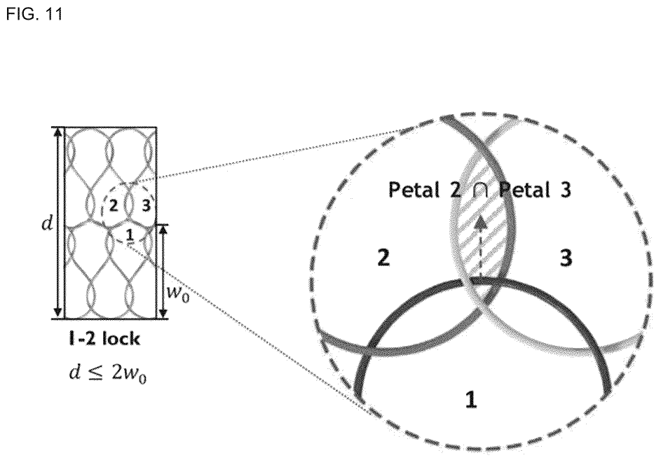

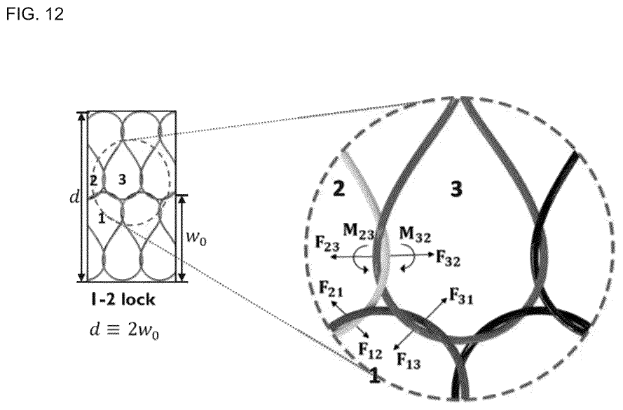

Next, a connection between the columns of the knot-based architecture may have a direct influence on the driving performance of the knot-architectured fabric actuator. The following description is provided by expanding the one column actuator based on the two-petal knot into the fabric actuator, selecting three representative connection types from various column connection possibilities, and comparing respective impacts of the connection types on the driving performances with one another. FIGS. 10 to 12 are diagrams showing various column connection types, where FIG. 10 shows free connection, FIG. 11 shows mean connection, and FIG. 12 shows force connection.

The free connection in FIG. 10 may be featured in individual petals where one petal is secured to another column, and a petal tip may be moved in a free region shaded with hatches, thus limiting a distance between two columns to d≤2w0. In the force connection in FIG. 12, the distance between the two columns may be always equal to 2w0 because each petal locks movements of two petals adjacent to another column, and a reaction force caused by the contact and constraint of the petals inhibits relative movements of the petals. The mean connection in FIG. 11 may partially maintain the features of the free connection and the force connection by securing the two adjacent petals to another column, and forming a free movement region at the crossing point of the petals.

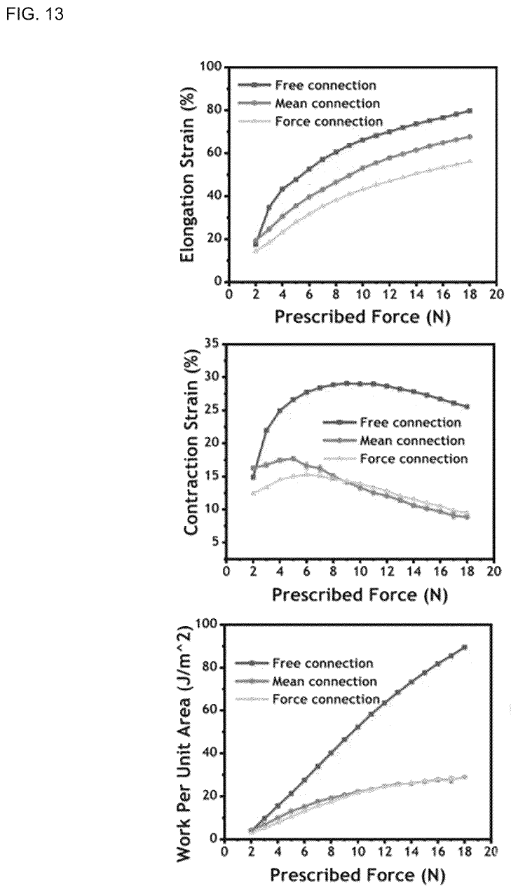

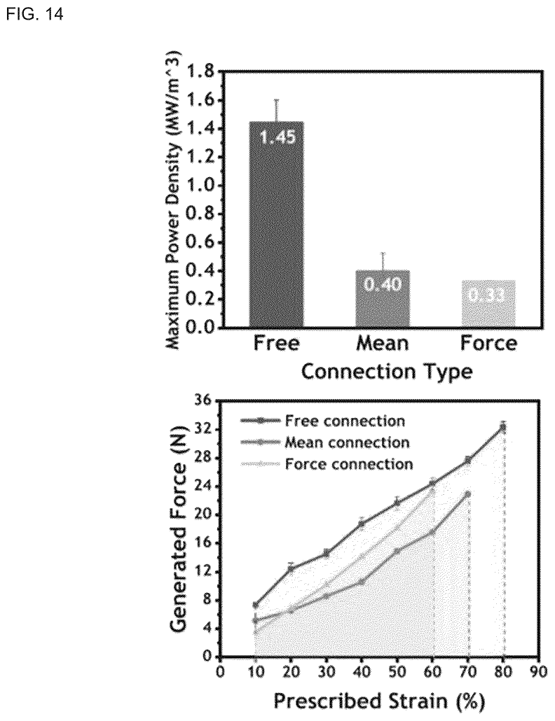

When having the different column connection methods, the knot-based fabric actuator may have very different mechanical couplings, and thus have different operation performances. FIG. 13 is a graph comparing the elongation strain, the contraction strain, and the work per unit length of the respective knot architectures with one another for each column connection type, and FIG. 14 is a graph comparing and evaluating performances of the knot architectures with one another based on the maximum power density and the generated force for each column connection type. It may be seen that the uppermost graph of FIG. 13 compares the elongation strains, and the free connection-based actuator shows the highest elasticity of reaching an elongation of 80% at 18 N. On the other hand, it may be seen that the force connection-based actuator has the lowest elongation strain, and may thus be the stiffest. The middle graph of FIG. 13 compares the contraction strains. The free connection-based actuator may generate a much larger contraction than the other connection-based actuators, and generate a contraction of up to 29% when a force of 9 N is applied thereto. When the prescribed force is increased to 18 N, the contraction strains of the other connection-type actuators may be reduced to 10% or less while the contraction strain of the free connection-based actuator is maintained to 25% or more. Therefore, it may be seen that the free connection method provides the greatest driving force to the fabric actuator. The lowermost graph of FIG. 13 compares work per unit area, and it may be seen that the free connection-based actuator generates a relatively high value of 90 J/m2 at 18 N while the two actuators, i.e., force connection-based actuator and mean connection-based actuator, show similarly low performances.

An upper graph of FIG. 14 compares the maximum power density based on each column connection type, and it may be seen that the free connection-based actuator may perform more mechanical work at a much faster rate than the force connection-based actuator or the mean connection-based actuator. This difference in power density performance may occur due to a hindered contraction because the columns of the force connection method or those of the mean connection method have limited degrees of freedom to be provided thereto while the columns of the free connection method have sufficient degrees of freedom to be operated without interfering with each other. A lower graph of FIG. 14 shows that different strain spectra need to be selected based on the force to be generated. As shown in the drawing, the free connection has a wide strain range, making it advantageous to utilize the force generated by the fabric actuator, and may generate a force of 32.3 N at a specified strain of 80%. The force of 32.3 N is 1373 times a weight (2.4 g) of the fabric actuator. As a result, it may be seen that the free connection-based fabric actuator has the highest values in each of the elasticity, the actuation capacity, the mechanical work, and the power density, and the free connection is thus the most suitable column connection for the knot-architectured fabric actuator.

From the comparative experiment results described above, it may be seen that the fabric actuator formed by expanding the two-petal knot and connecting the same by the free connection may generate a much larger force than the conventional actuator. The knot-architectured fabric actuator may have 380 N/m as the prescribed force of 32.3 N divided by a fabric width of 8.5 cm, which is 4.3 times higher than 89 N/m of the fabric actuator that is reported in the literature.

The knot-architectured fabric actuator according to the present disclosure shows advantages in terms of Joule heating and the mechanical robustness in addition to the large force generation. Hereinafter, the description describes in detail a mechanism of the knot-architectured fabric actuator that enables its excellent performance.

### <Self-Locking Property and Force Transmission Efficiency>

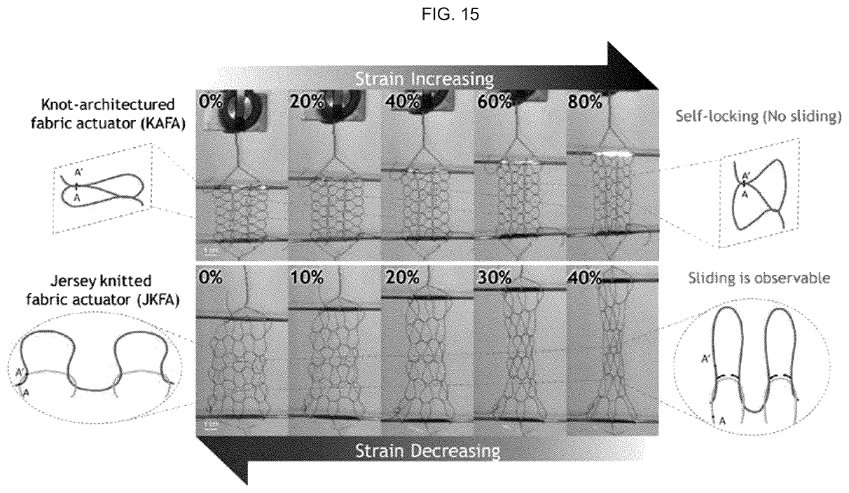

Hereinafter, the description describes the mechanism by which the knot-architectured fabric actuator may generate the large force based on its self-locking property and force transmission efficiency. First, it is possible to neglect a shear stress and a bending moment of a divided cross-section due to a large length-diameter ratio of a nitinol fiber. Therefore, when considering only a result of an axial force by a normal stress in the cross-section, the knot-architectured fabric actuator may have two axial forces of similar magnitude at the crossing point, and the knot-architectured fabric actuator may thus be self-locked at the crossing point. On the other hand, a jersey knitted fabric actuator may have two axial forces of different magnitude at the crossing point, which causes the knot to slip. FIG. 15 shows experiment results of the self-locking of the knot-architectured fabric actuator according to an embodiment of the present disclosure and the sliding operation of the conventional jersey knitted fabric actuator. It may be seen that in the knot-architectured fabric actuator, the sliding does not occur due to its self-locking even as the strain is increased, and in the jersey knitted fabric actuator, the sliding occurs as the strain is increased.

Meanwhile, when the unit knot expands into the column, in the case of the four-petal knot, the knot may be connected with the other two knots disposed on both sides thereof and having two force transmission crossing points, and eight excessive friction crossing points that greatly hinder the performance of the four-petal actuator may exist therein; and in the case of the one-petal knot, each knot may be connected with two knots disposed on both sides thereof, and have two force transmission crossing points and zero non-force transmission crossing points. On the other hand, in the case of the two-petal knot, each knot may be connected with the other two knots disposed on both sides thereof, and have the largest number of force transmission crossing points of 4 and the smallest number of non-force transmission crossing points of zero. This force transmission crossing point may serve an important function in high performance of the knot-based actuator, which describes that the two-petal knot may be used as a suitable unit knot pattern.

### <Electric Heating and Heat Distribution>

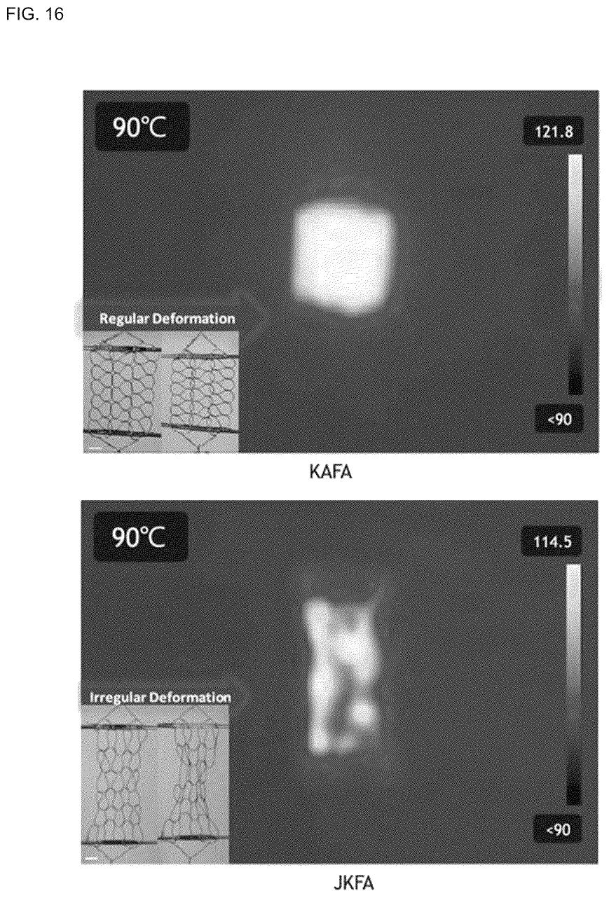

It is necessary to investigate a current flow in a fabric architecture to describe a principle by which the knot-architectured fabric actuator may be operated using Joule heating. An electrical resistance of a nitinol material may oscillate over time due to a coupling between an electric field, a thermal field, and a stress field. In order to ensure time constancy of the electrical resistance, electric Joule heating is applied for sufficient time and with constant power input, both sides of the fabric actuator are secured, and some pretension is added to ensure full contact at the crossing point. As a result of experiments performed under these conditions, in the case of the jersey knitted fabric actuator, Joule heating may not be possible due to the presence of equipotential adjacent nodes that cause a short circuit. However, in the case of the knot-architectured fabric actuator, continuous fluctuations appear in a potential value, and it may thus be seen that there is a potential difference that may generate the current flow for Joule heating at the adjacent nodes. FIG. 16 shows the temperature distribution and the mechanical deformation during Joule heating of each of the knot-architectured fabric actuator according to an embodiment of the present disclosure and that of the conventional jersey knitted fabric actuator. It may be seen that in the case of the jersey knitted fabric actuator shown in a lower drawing, heat conduction is not fast enough when a shape recovery of the nitinol filament starts to thus fail to uniformly distribute heat, thereby causing non-uniform deformation of the jersey knitted fabric actuator. On the other hand, in the case of the knot-architectured fabric actuator shown in an upper drawing, uniform heat dissipation and uniform deformation may be generated.

### <Wearable Actuator>

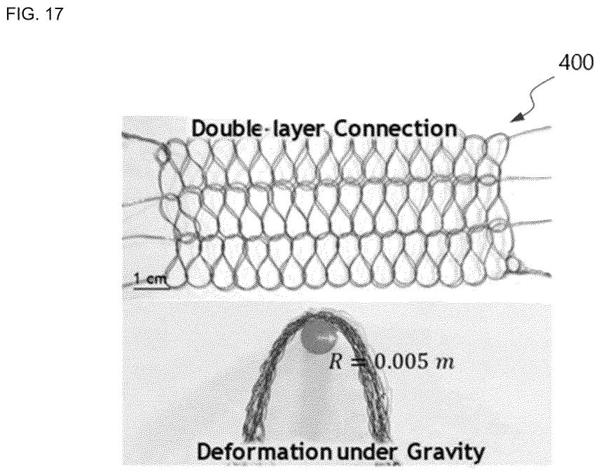

The knot-architectured fabric actuator may be soft and lightweight, and have great actuation force and strain, may thus be suitable for wearable and soft robotics applications, and resemble a real fabric. Therefore, the knot-architectured fabric actuator may be easily connected with each other in a multi-layer to further amplify the driving force. FIG. 17 shows an example of using two layers of the knot-architectured fabric actuator. When two layers of the knot-architectured fabric actuator are connected with each other, it is possible to generate a much larger force and enable its deformation having a small curvature radius. In addition, such a multi-layered knot-architectured fabric actuator 400 may be suitable for the human body having a flexible and non-uniform movement. In addition, the actuator may be light and have a deformable shape, may thus be stretched or twisted like cloth used in daily life, and have many advantages such as softness, a light weight, a low-noise operation, and a low-voltage input.

In addition, the knot-architectured fabric actuator may have soft and adaptable features, thus be suitable for any complex appearances of a variety of objects, and when adjusting fabric processing, the knot-architectured fabric actuator may expand to have a cylindrical surface enabling the actuator to easily grip the variety of objects regardless of a surface shape and a material property. The cylindrical surface may enable the actuator to be controlled to be contracted based on an electrical command and adjusted to various sizes of the gripped object.

In addition, in a case of a conventional soft gripper, the gripper may be damaged when gripping a pointed object having a sharp spine. However, the knot-architectured fabric actuator may pass through a porous fabric surface, and thus also be used as the soft gripper. In addition, the knot-architectured fabric actuator may easily grip another complex appearance to thus quietly wrap a fragile light bulb or a slippery beaker and safely transport the same without breakage, may have the large force generated by the knot architecture to thus prevent a heavy or slippery object from being dropped in a process of holding and transporting the object, and may adapt to the appearance of the object and have a minimal contact pressure to thus protect the fragile object from the breakage. Unlike the conventional soft gripper which may reduce a contact pressure by deforming a soft material, the knot-architectured fabric actuator may control its pressure by adjusting input power. The actuator may utilize the contact area by using the new structural reconfiguration and size fitting of its cylindrical surface, thus making it applicable to more applications in the future.

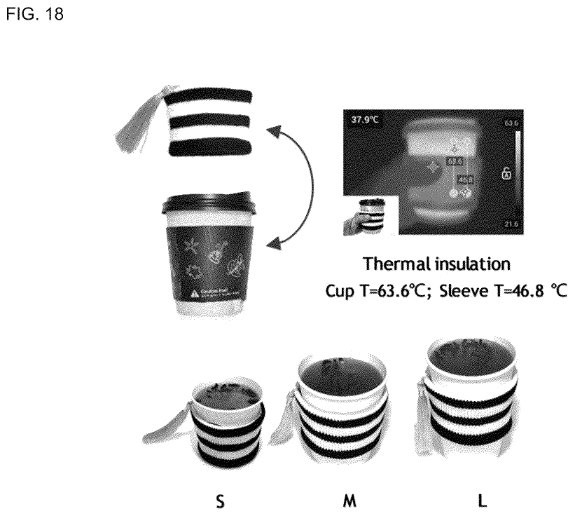

In addition, the knot-architectured fabric actuator may also replace a disposable cup sleeve by encapsulating the grip surface of the soft gripper with an adaptive sleeve as shown in FIG. 18. The adaptive sleeve may be easily worn on a person's wrist as an aesthetic accessory in daily life. At any time, the wearer may take off the adaptive sleeve and use the same to hold a hot teacup. Meanwhile, the encapsulated knot-architectured fabric actuator may absorb heat conducted from the hot cup to thus generate a grip force. Therefore, the soft gripper formed with an adaptive sleeve may be firmly secured to the cup without slipping. As may be seen in a thermal image in an upper right of the drawing, the adaptive sleeve may effectively block heat occurring in the cup and lower its temperature, thus protecting the wearer's hand. In addition, the adaptive sleeve not only may be used multiple times compared to a conventional cup sleeve, but may also be used to fit a variety of cup sizes.

As set forth above, the knot-architectured fabric actuator of the present disclosure and the conventional jersey knitted fabric actuator are different from each other in respectively having the knot architecture and the jersey knitted architecture. Therefore, knot-architectured fabric actuator may have a cross contact point perpendicular to its operation direction, thus enabling its efficient force transmission, may have the conductive circuit network without a short circuit, thus enabling its convenient use, may be operated with Joule heating, and may have the mechanical robustness.

In addition, the knot-architectured fabric actuator may generate its unique actuation behavior due to the differences in terms of the geometric topology and the mechanical feature, implement the expansion, contraction, bending, and twisting movements by using various weaving architectures, induce an auxiliary or shearing motion when woven with Ceylon stitch, and enable tubular constriction through its braided architecture.

In addition, the knot-architectured fabric actuator may implement the various features and functions enabling the actuator to be applied to various purposes when the knot architecture uses the various smart materials including an electroactive polymer, a carbon nanotube yarn, a conductive polymer, and a twisted and coiled polymer, and may provide its customized performance to suit a specific requirement or achieve its optimal performance by adjusting the parameter, when flexibly selecting the unit knot size, the fiber diameter, and the overall length and width of the architecture after determining its configuration material.

Meanwhile, the embodiment of the present disclosure also suggests the practical and useful applications utilizing the knot-architectured fabric actuator. The wearable actuator, which uses the knot-architectured fabric actuator of the present disclosure, may be smoothly and quietly operated to support a mannequin lifting a load, may have the adaptive control surface to thus grip the various objects having the complex appearances or to be encapsulated and used as the adaptable sleeve for holding the hot teacup. In addition, the knot-architectured fabric actuator may be applied to a biomedical component or a lightweight aerospace structure by fabricating the knot architecture in a micro or macro scale.

The present disclosure is not limited to the above-described embodiments, may be variously applied, and may be variously modified by any of those skilled in the art to which the present disclosure within an equivalent range of the present disclosure claimed in the appended claims.

1. A knot-architectured fabric actuator comprising:
at least one knot including a node formed by fiber strands crossing each other; and
at least one petal including a closed curve formed by fibers extending from both ends of the knot.

2. The actuator of claim 1, wherein the at least one knot and the at least one petal extend in one direction to form a column.

3. The actuator of claim 2, wherein the column extends in the other direction to form a two-dimensional architecture.

4. The actuator of claim 3, wherein two or more of the two-dimensional architectures overlap each other to form a multi-layer.

5. The actuator of claim 1, wherein two knots and two petals form a unit knot.

6. The actuator of claim 5, wherein d≤2w0, here, w0 indicates a width of the unit knot, and d indicates a distance from one side of one unit knot to the other side of another unit knot adjacent thereto in a width direction when the unit knot extends in the width direction.

7. The actuator of claim 1, wherein the fiber is a shape memory polymer.

8. A wearable robot including the actuator of claim 7.

9. A soft gripper including the actuator of claim 7.

10. The soft gripper of claim 9, wherein the soft gripper is formed with an adaptive sleeve surrounding a surface of an object.
